(19) United States
(12) Patent Application Publication
(10) Pub. No.: US 2024/0391827 A1
(43) Pub. Date: Nov. 28, 2024

(54) METHODS OF FORMING ANTI-GLARE SURFACE STRUCTURE WITH CO-LOCATED REFRACTIVE INDEX CONTRAST IN LAMINATED GLASS SUBSTRATES USING ULTRAFAST LASERS AND ANTI-GLARE LIGHT-TRANSMITTING STRUCTURES WITH LOW SPARKLE AND LOW DISTINCTINESS-OF-IMAGE FORMED FROM SUCH METHODS

(71) Applicant: CORNING INCORPORATED, CORNING, NY (US)

(72) Inventors: Jonathan Thomas Beall, Corning, NY (US); Nikolaus Jon Deems, Elmira, NY (US); Yuhui Jin, Painted Post, NY (US); Xinghua Li, Horseheads, NY (US); Ying Liu, Kennett Square, PA (US); Lei Yuan, Painted Post, NY (US); Liying Zhang, Painted Post, NY (US)

(21) Appl. No.: 18/669,842

(22) Filed: May 21, 2024

Related U.S. Application Data
(60) Provisional application No. 63/468,577, filed on May 24, 2023.

(51) Int. Cl. C03C 23/00; C03B 17/06; C03C 15/00; G02B 5/02

(52) U.S. Cl. CPC C03C 23/0025; C03C 15/00; G02B 5/0268; G02B 5/0278; C03B 17/064

(57) ABSTRACT

A light-transmitting structure is disclosed. The light-transmitting structure includes a laminated glass substrate that has a core layer and a first clad layer fused to a first side of the core layer. The core layer comprises a core glass composition that is transparent and has a core refractive index n_{C}. The first clad layer defines a first surface of the laminated glass substrate and comprises a first clad glass composition that is transparent and has a first clad refractive index n_{CL1} that is lower than the core refractive index n_{C}. The light-transmitting structure further includes a plurality of interdiffusion regions that extend from the core layer and through the first clad layer to define a light-scattering surface interposed with the first surface. Each interdiffusion region comprises an interdiffusion composition that is transparent and has an interdiffusion refractive index n_{I} that is higher than the first clad refractive index n_{CL1}.

### CROSS-REFERENCE TO RELATED APPLICATIONS

This application claims the benefit of priority under 35 U.S.C. § 119 of U.S. Provisional Application No. 63/468,577 filed May 24, 2023, the content of which is incorporated herein by reference in its entirety.

### FIELD

The present disclosure relates to light-transmitting structures with anti-glare (AG) properties and, more particularly, to methods of forming AG surface structure with co-located refractive index contrast in laminated glass substrates using ultrafast lasers and AG light-transmitting structures with low sparkle and low distinctness-of-image formed from such methods.

### BACKGROUND

Portable electronic devices, such handheld devices (e.g., smartphones, tablets, etc.) and wearable devices (e.g., watches, fitness trackers, etc.), utilize glass-based materials. For example, cover glass or screens on such portable electronic devices can be made of glass-based materials. Optical properties associated with good viewing of the screen are generally sought. Mechanical properties intended to prevent or mitigate optical or structural issues from scratches, impact events (e.g., from drops), excessive flexure, or the like are also desired. Coatings or other surface treatments can be used to enhance glass-based materials. However, current glass-based materials have optical and/or mechanical limitations.

Accordingly, a need exists for glass-based materials with different optical and mechanical characteristics, and methods of producing such materials. This need and other needs are addressed by the present disclosure.

### SUMMARY

A first aspect of the present disclosure includes a light-transmitting structure, comprising: a laminated glass substrate comprising a core layer and a first clad layer fused to a first side of the core layer, the core layer comprising a core glass composition that is transparent and has a core refractive index n_{C}, the first clad layer defining a first surface of the laminated glass substrate and comprising a first clad glass composition that is transparent and has a first clad refractive index n_{CL1} that is lower than the core refractive index n_{C}; and a plurality of interdiffusion regions extending from the core layer and through the first clad layer to define a light-scattering surface interposed with the first surface, each interdiffusion region comprising an interdiffusion composition that is transparent and has an interdiffusion refractive index n_{I} that is higher than the first clad refractive index n_{CL1}, the first surface and the light-scattering surface defining an interface to an ambient environment.

A second aspect of the present disclosure includes a method for forming a light-transmitting structure, comprising: irradiating a laminated glass substrate with a beam from a laser, the laminated glass substrate comprising a core layer and a first clad layer fused to the core layer, the core layer comprising a core glass composition that is transparent and has a core refractive index n_{C}, the first clad layer defining a first surface of the laminated glass substrate and comprising a first clad glass composition that is transparent and has a first clad refractive index n_{CL1} that is lower than the core refractive index n_{C}, wherein the irradiating is configured to form a plurality of interdiffusion regions that extend from the core layer into the first clad layer, each interdiffusion region comprising an interdiffusion composition that is transparent and has an interdiffusion refractive index n_{I} that is higher than the first clad refractive index n_{CL1}.

### BRIEF DESCRIPTION OF THE DRAWINGS

FIG. 1 is a schematic cross-sectional view of a laminated glass substrate with a substrate surface that can be textured to form a textured light-transmitting structure;

FIG. 2 schematically depicts an apparatus for forming the laminated glass substrate of FIG. 1;

FIG. 3 is a conceptual top-down view of a textured light-transmitting structure with an ordered pattern of interdiffusion regions in the laminated glass substrate;

FIG. 4 is a conceptual top-down view of a textured light-transmitting structure with a random pattern of interdiffusion regions in the laminated glass substrate;

FIG. 5. is a schematic cross-sectional view through a textured portion of the light-transmitting structure of FIG. 1 showing the interdiffusion regions configured to define a light-scattering surface interposed with the substrate surface;

FIG. 6 is a simplified view of the light-scattering surface and the substrate surface of FIG. 5 forming a substrate-environment interface comprising peaks and valleys, the interdiffusion regions configured to define the valleys;

FIG. 7A is a plan view of an exemplary electronic device incorporating a light-transmitting structure;

FIG. 7B is a perspective view of the exemplary electronic device of FIG. 6A;

FIG. 8 is a schematic cross-sectional view through a portion of a laminated glass substrate to illustrate an irradiating step a method for forming a light-transmitting structure;

FIG. 9 is a schematic cross-sectional view through a portion of a laminated glass substrate to illustrate an etching step a method for forming a light-transmitting structure;

FIG. 10 schematically depicts a laser system configured to perform the laser processing of laminated glass substrate samples according to the Examples;

FIG. 11 is a scanning electron microscope (SEM) image of interdiffusion regions formed via ultrafast laser in a laminated glass substrate sample made from a first combination of core and clad glass compositions;

FIG. 12 is a series of images including (from left to right) an enlarged SEM image of an interdiffusion region formed in the sample of FIG. 11 and two corresponding energy dispersive spectrometry (EDS) elemental mapping images of the SEM image area;

FIG. 13 is a SEM image of interdiffusion regions formed via ultrafast laser in a laminated glass substrate sample made from a second combination of core and clad glass compositions; and

FIG. 14 is a group of images including an enlarged SEM image of a group of interdiffusion regions formed in the sample of FIG. 13 and three corresponding EDS elemental mapping images of the SEM image area.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “average coefficient of thermal expansion,” or “average CTE,” refers to the average coefficient of linear thermal expansion of a given material or layer between 0° C. and 300° C. As used herein, the term “coefficient of thermal expansion,” or “CTE,” refers to the average coefficient of thermal expansion unless otherwise indicated. The CTE can be determined, for example, using the procedure described in ASTM E228 “Standard Test Method for Linear Thermal Expansion of Solid Materials With a Push-Rod Dilatometer” or ISO 7991:1987 “Glass—Determination of coefficient of mean linear thermal expansion.

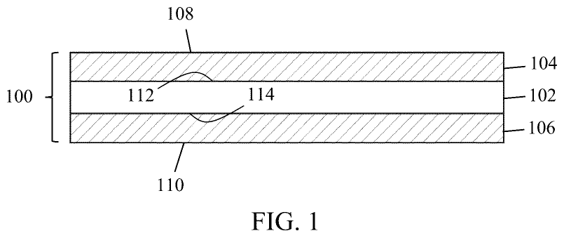

Referring now to FIG. 1, a laminated glass substrate 100 that can be configured to form a light-transmitting structure is schematically depicted. The laminated glass substrate 100 comprises a plurality of glass-based layers. In embodiments, the laminated glass substrate 100 can be substantially planar, as shown in FIG. 1, or the laminated glass substrate 100 can be non-planar. In embodiments, the laminated glass substrate 100 is a laminated sheet that includes the plurality of (fused) glass-based layers. The laminated glass substrate 100 comprises a glass core layer 102 (hereinafter “core layer”) disposed between a first glass clad layer 104 (hereinafter “first clad layer”) and a second glass clad layer 106 (hereinafter “second clad layer”). In embodiments, the first clad layer 104 and/or the second clad layer 106 can be exterior layers relative to the core layer 102. For example, the first clad layer 104 can define an outer or first surface 108 of the laminated glass substrate 100 and/or the second clad layer 106 can define an outer or second surface 110 of the laminated glass substrate 100, as shown in FIG. 1.

The core layer 102 comprises a first major surface and a second major surface opposite the first major surface. In embodiments, the first clad layer 104 is fused to the first major surface of the core layer 102, and the second clad layer 106 is fused to the second major surface of the core layer 102. In such embodiments, an interface 112 (e.g., a first interface) between the first clad layer 104 and the core layer 102 and/or an interface 114 (e.g., a second interface) between the second clad layer 106 and the core layer 102 are free of any bonding material such as, for example, an adhesive, a coating layer, or any non-glass material added or configured to adhere the respective clad layers to the core layer. Thus, the first clad layer 104 and/or the second clad layer 106 are fused directly to the core layer 102 and/or are directly adjacent to the core layer 102. The first surface 108 may be referred to as a first major surface, and the second surface 110 may be referred to as a second major surface since the first and second clad layers 104, 106 are fused to the first and second major surfaces, respectively, of the core layer 102.

In embodiments, the laminated glass substrate 100 can include one or more intermediate layers disposed between the core layer and the first clad layer and/or between the core layer and the second clad layer. For example, the intermediate layers can comprise intermediate glass layers and/or diffusion layers formed at the interface of the core layer and the clad layer. The diffusion layer can comprise a blended region comprising components of each layer adjacent to the diffusion layer (e.g., a blended region between two directly adjacent glass layers).

In embodiments, the laminated glass substrate 100 is mechanically strengthened. For example, the laminated glass substrate 100 can be configured such that at least one of the first and second clad layers 104, 106 and the core layer 102 have different coefficients of thermal expansion (CTE), though in other embodiments such CTE mismatch can be substantially zero or zero. In embodiments, at least one of the first and second clad layers 104, 106 is formed from a clad glass composition and has an average clad coefficient of thermal expansion CTE_{CL} that is less than an average core coefficient of thermal expansion CTE_{C} of a core glass composition that forms the core layer 102. Suitable glass compositions used to form the core layer and the clad layers of the laminated glass substrate 100 are described later in this disclosure. The CTE mismatch (i.e., the difference between the CTE_{CL} of the first and second clad layers 104, 106 and the CTE_{C} of the core layer 102) results in the formation of compressive stress (CS) and depth of layer (DOL) in the clad layers and tensile stress in the core layer upon cooling of the laminated glass substrate 100. In embodiments, the compressive stress and the depth of layer can be formed only by CTE mismatch (i.e., mechanical strengthening) and without ion exchange (i.e., chemical strengthening) or heat-treatment (i.e., thermal strengthening).

In embodiments, a difference between CTE_{C} and CTE_{CL} (e.g., CTE_{C}−CTE_{CL}) is in a range of from about 0×10-7/° C. to about 50×10⁻⁷/° C., or from about 2×10⁻⁷/° C. to about 45×10⁻⁷/° C., or from about 5×10⁻⁷/° C. to about 37.5×10⁻⁷/° C., or from about 8×10⁻⁷/° C. to about 30×10⁻⁷/° C., or from about 11×10⁻⁷/° C. to about 22.5×10⁻⁷/° C., or from about 0×10⁻⁷/° C. to about 42.5×10⁻⁷/° C., or from about 0×10⁻⁷/° C. to about 35×10⁻⁷/° C., or from about 0×10⁻⁷/° C. to about 27.5×10⁻⁷/° C., or from about 0×10⁻⁷/° C. to about 20×10⁻⁷/° C., and comprising all sub-ranges and sub-values between these range endpoints.

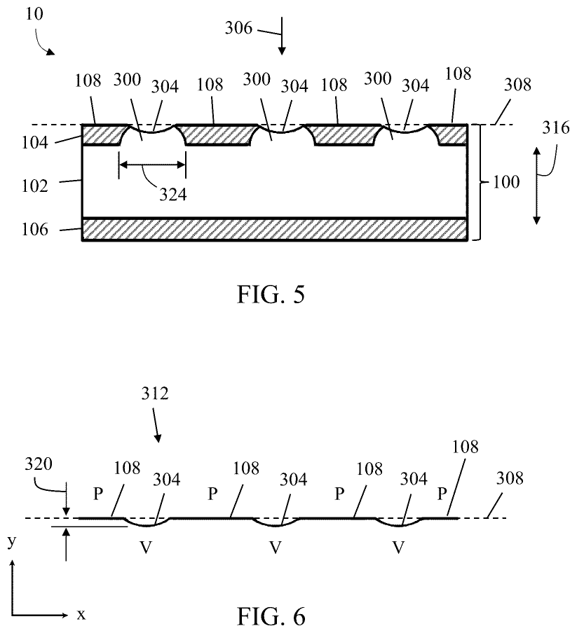

The laminated glass substrate 100 has a total thickness measured in a direction approximately normal to the first and second (major) surfaces 108, 110 (e.g., the direction of arrow 316 in FIG. 5). Since the laminated glass substrate 100 comprises multiple glass-based layers, the total thickness of the laminated glass substrate 100 includes the individual thicknesses of each glass-based layer. In the exemplary embodiments disclosed herein, the total thickness of the laminated glass substrate 100 includes a core thickness of the core layer 102, a first clad thickness of the first clad layer 104, and a second clad thickness of the second clad layer 106. In embodiments, the first and second clad thicknesses can be equal (e.g., symmetric about the core layer 102). Alternatively, the first and second clad thicknesses can be different (e.g., asymmetric about the core layer 102).

In embodiments, the total thickness of the laminated glass substrate 100 is in a range of from greater than or equal to about 200 μm (0.200 mm) to less than or equal to about 3800 μm (3.800 mm), such as greater than or equal to 300 μm (0.300 mm) to less than or equal to 3000 μm (3.000 mm), greater than or equal to 350 μm (0.350 mm) to less than or equal to 2500 μm (2.500 mm), greater than or equal to 400 μm (0.400 mm) to less than or equal to 2000 μm (2.000 mm), greater than or equal to 450 μm (0.450 mm) to less than or equal to 1850 μm (1.850 mm), greater than or equal to 500 μm (0.500 mm) to less than or equal to 1800 μm (1.800 mm), greater than or equal to 550 μm (0.550 mm) to less than or equal to 1750 μm (1.750 mm), greater than or equal to 600 μm (0.600 mm) to less than or equal to 1700 μm (1.700 mm), greater than or equal to 650 μm (0.650 mm) to less than or equal to 1650 μm (1.650 mm), greater than or equal to 700 μm (0.700 mm) to less than or equal to 1600 μm (1.600 mm), greater than or equal to 750 μm (0.750 mm) to less than or equal to 1550 μm (1.550 mm), greater than or equal to 800 μm (0.800 mm) to less than or equal to 1500 μm (1.500 mm), greater than or equal to 850 μm (0.850 mm) to less than or equal to 1450 μm (1.450 mm), greater than or equal to 900 μm (0.900 mm) to less than or equal to 1400 μm (1.400 mm), greater than or equal to 950 μm (0.950 mm) to less than or equal to 1350 μm (1.350 mm), greater than or equal to 1000 μm (1.000 mm) to less than or equal to 1300 μm (1.300 mm), greater than or equal to 1050 μm (1.050 mm) to less than or equal to 1250 μm (1.250 mm), greater than or equal to 1100 μm (1.100 mm) to less than or equal to 1200 μm (1.200 mm), greater than or equal to 1150 μm (1.150 mm) to less than or equal to 1175 μm (1.175 mm), and any and all sub-ranges formed from any of these endpoints.

The core thickness t_{core} and the clad thicknesses t_{clad} (e.g., when the first and second clad thicknesses are equal) can be expressed as a core/clad thickness ratio R, where R=t_{core}/2t_{clad}. The core thickness and the clad thicknesses can be determined with reference to the total thickness of the laminated glass substrate 100 and the core/clad thickness ratio R. In embodiments, R can be any one of 0.5, 1, 2, 3, 4, 5, 6, 7, 8, 9, or 10, or any value between these endpoints. In embodiments, R can be less than or greater than these endpoints.

The glass compositions used to form the core layer and the clad layers of the laminated glass substrate 100 may include several suitable glass compositions. For example, the glass compositions can include a combination of SiO₂ and Al₂O₃. The glass compositions can also include at least one alkaline earth oxide, such as BeO, MgO, CaO, SrO and BaO, and/or at least one alkali oxide, such as Li₂O, Na₂G, K₂O, Rb₂O and Cs₂O. In embodiments, the glass compositions are alkali-free, while in other embodiments, the glass compositions include one or more alkali oxides. In embodiments, the glass compositions can further include minor amounts of one or more additional oxides, such as, by way of example and not limitation, SnO₂, Sb₂O₃, ZrO₂, ZnO, or the like. These components can be added as fining agents and/or to further modify the CTE of the glass composition.

In embodiments, the glass compositions used to form the core layer and the clad layers can include SiO₂ in an amount from greater than or equal to about 35 wt. % to less than or equal to about 80 wt. %, Al₂O₃ in an amount from greater than or equal to about 1.5 wt. % to less than or equal to about 25 wt. %, B₂O₃ in amounts discussed below, P₂O₅ in an amount from greater than or equal to about 0 wt. % to less than or equal to about 25 wt. %, one or more alkali oxides (e.g., Na₂G, K₂O, Li₂O, or the like) in an amount from greater than or equal to about 0 wt. % to less than or equal to about 40 wt. %, and one or more alkaline earth oxides (e.g., MgO, CaO, SrO, BaO, or combinations thereof) in an amount from greater than or equal to about 0 wt. % to less than or equal to about 22 wt. %.

The clad glass composition can further include B₂O₃ in an amount from greater than or equal to about 10 wt. % to less than or equal to about 50 wt. % B₂O₃. In comparison, in embodiments, the core glass composition can further include B₂O₃ in an amount from greater than or equal to about 0 wt. % to less than or equal to about 20 wt. %. In embodiments, the amount of alkali oxide R₂O in the core glass composition, where R is at least one of Li, Na, or K, is different than the amount of alkali oxide R₂O in the clad glass composition. Such a difference in R₂O can enable a chemical durability gradient (e.g., different etch rate in an etchant), a CTE differential, and/or different stress profiles between glass layers formed from the core glass composition and the clad glass composition. In embodiments, the core glass composition comprises a higher amount of alkali oxide R₂O than the first clad glass composition. In embodiments, the higher R₂O in the core glass composition enables the core CTE to be higher than the clad CTE.

In embodiments, the glass compositions used to form the core layer and the clad layers are transparent. As used herein, the term “transparent” is intended to mean that the laminated glass substrate 100 has an optical transmission of greater than about 80% (e.g., over a length or thickness of about 0.5 mm) in the visible region of the spectrum (e.g., from about 380 nm to about 770 nm). For instance, an exemplary transparent composition may have greater than about 85% transmittance in the visible light range, such as greater than about 90%, greater than about 95%, or greater than about 99% transmittance, including all ranges and subranges therebetween. Since the laminated glass substrate 100 comprises multiple glass-based layers, it will be appreciated that the glass composition of each glass-based layer is transparent.

The glass compositions used to form the core layer and the clad layers of the laminated glass substrate 100 can include the glass compositions disclosed in U.S. Patent Application Publication No. 2022/0144681 A1, published on May 12, 2022, which is incorporated herein by reference in its entirety.

In embodiments, the glass compositions used to form the core layer and the clad layers of the laminated glass substrate 100 have a liquidus viscosity suitable for forming the laminated glass substrate 100 using a fusion draw process as described herein. For example, each of the glass compositions may have a liquidus viscosity of at least about 100 kP, at least about 200 kP, or at least about 300 kP. Additionally, or alternatively, the core glass composition comprises a liquidus viscosity of less than about 3000 kP, less than about 2500 kP, less than about 1000 kP, or less than about 800 kP. The clad glass composition of the clad layers 104 and 106 may have a liquidus viscosity of at least about 50 kP, at least about 100 kP, or at least about 200 kP. Additionally, or alternatively, the clad glass composition comprises a liquidus viscosity of less than about 3000 kP, less than about 2500 kP, less than about 1000 kP, or less than about 800 kP. The core glass composition can aid in carrying the clad glass composition over the overflow distributor to form the clad layer. Accordingly, the clad glass composition can have a liquidus viscosity that is lower than generally considered suitable for forming a single layer sheet using a fusion draw process.

A variety of processes may be used to produce the laminated glass substrate 100 described herein including, without limitation, lamination slot draw processes, lamination float processes, or fusion lamination processes. Each of these lamination processes generally involves flowing a first molten glass composition, flowing a second molten glass composition, and contacting the first molten glass composition with the second molten glass composition at a temperature greater than the glass transition temperature of either glass composition to form an interface between the two compositions such that the first and second molten glass compositions fuse together at the interface as the glass cools and solidifies. In an exemplary embodiment, the laminated glass substrate 100 described herein can be formed by a fusion lamination process such as the process described in U.S. Pat. No. 4,214,886, issued on Jul. 29, 1980, which is incorporated herein by reference in its entirety.

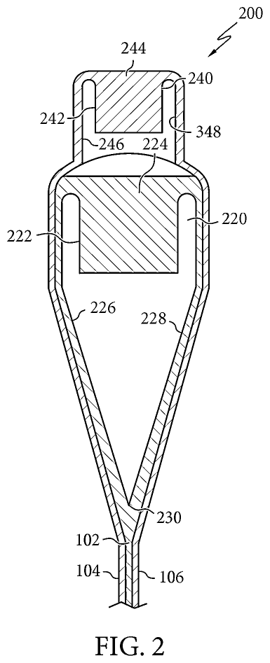

Referring now to FIG. 2 by way of example, a laminate fusion draw apparatus 200 for forming a laminated glass substrate is shown. For example, the fusion draw apparatus 200 includes a lower overflow distributor 220 and an upper overflow distributor 240 positioned above the lower overflow distributor 220. The lower overflow distributor 220 includes a trough 222. A core glass composition 224 is melted and fed into the trough 222 in a viscous state. The core glass composition 224 forms the core layer 102 of the laminated glass substrate 100 as further described below. The upper overflow distributor 240 includes a trough 242. A clad glass composition 244 is melted and fed into the trough 242 in a viscous state. The clad glass composition 244 forms first and second clad layers 104, 106 of the laminated glass substrate 100 as further described below.

The core glass composition 224 overflows trough 222 and flows down opposing outer forming surfaces 226 and 228 of the lower overflow distributor 220. The outer forming surfaces 226 and 228 converge at a draw line or root 230. The separate streams of the core glass composition 224 flowing down respective outer forming surfaces 226 and 228 of the lower overflow distributor 220 converge at the draw line 230 where they are fused together to form the core layer 102 of the laminated glass substrate 100.

The clad glass composition 224 overflows the trough 242 and flows down opposing outer forming surfaces 246 and 248 of the upper overflow distributor 240. The clad glass composition 244 is deflected outward by the upper overflow distributor 240 such that the clad glass composition 244 flows around the lower overflow distributor 220 and contacts the core glass composition 224 flowing over the outer forming surfaces 226 and 228 of the lower overflow distributor 220. The separate streams of the clad glass composition 244 are fused to the respective separate streams of the core glass composition 224 flowing down the respective outer forming surfaces 226 and 288 of the lower overflow distributor 220. Upon convergence of the streams of the core glass composition 224 at the draw line 230, the clad glass composition 244 forms first and second clad layers 104, 106 of the laminated glass substrate 100.

In embodiments, the core glass composition 224 of the core layer 102 in the viscous state is contacted with the clad glass composition 244 of the first and second clad layers 104, 106 in the viscous state to form the laminated sheet. In some of such embodiments, the laminated sheet is part of a glass ribbon traveling away from the draw line 230 of the lower overflow distributor 220, as shown in FIG. 2. The glass ribbon can be drawn away from the lower overflow distributor 220 by a suitable means including, for example, gravity and/or pulling rollers. The glass ribbon cools as it travels away from the lower overflow distributor 220. The glass ribbon is severed to separate the laminated sheet therefrom. Thus, the laminated sheet is cut from the glass ribbon. The glass ribbon can be severed using a suitable technique such as, for example, scoring, bending, thermally shocking, and/or laser cutting. In embodiments, the laminated glass substrate 100 comprises the laminated sheet as shown in FIG. 1. In other embodiments, the laminated sheet can be processed further (e.g., by cutting or molding) to form the laminated glass substrate.

Although the laminated glass substrate 100 is shown in FIG. 1 as including three layers, other embodiments are contemplated. For example, the laminated glass substrate may have two, four, or more layers. Laminated glass substrates including two layers can be formed using two overflow distributors positioned such that the two layers are joined while traveling away from the respective draw lines of the overflow distributors or by using a single overflow distributor with a divided trough such that two glass compositions flow over opposing outer forming surfaces of the overflow distributor and converge at the draw line of the overflow distributor. Laminated glass substrates including four layers can be formed using additional overflow distributors and/or using overflow distributors with divided troughs. Thus, a laminated glass substrate having a predetermined number of layers can be formed by modifying the overflow distributor accordingly.

Substrate surfaces with conventional antiglare (AG) texture may have low sparkle or low distinctness-of-image (DOI), but usually not both. In contrast, the light-transmitting structure of the present disclosure includes features configured to give the surfaces of the laminated glass substrate 100 an AG texture that possesses both low sparkle and low DOI. Throughout this disclosure, surfaces, substrates, and/or structures that include such features can include the modifier “textured” and be referred to as a textured surface, a textured substrate, and/or a textured structure, respectively. In embodiments, a portion of the first surface 108 can be textured. In embodiments, the textured portion of the first surface 108 can cover an entirety of the first surface 108. In embodiments, a portion of the first surface 108 and a portion of the second surface 110 can be textured. In embodiments, an entirety of the first surface 108 and an entirety of the second surface 110 can be textured. In embodiments, edge surfaces of the laminated glass substrate 100, extending between the first and second surfaces 108, 110, can additionally or alternatively be textured.

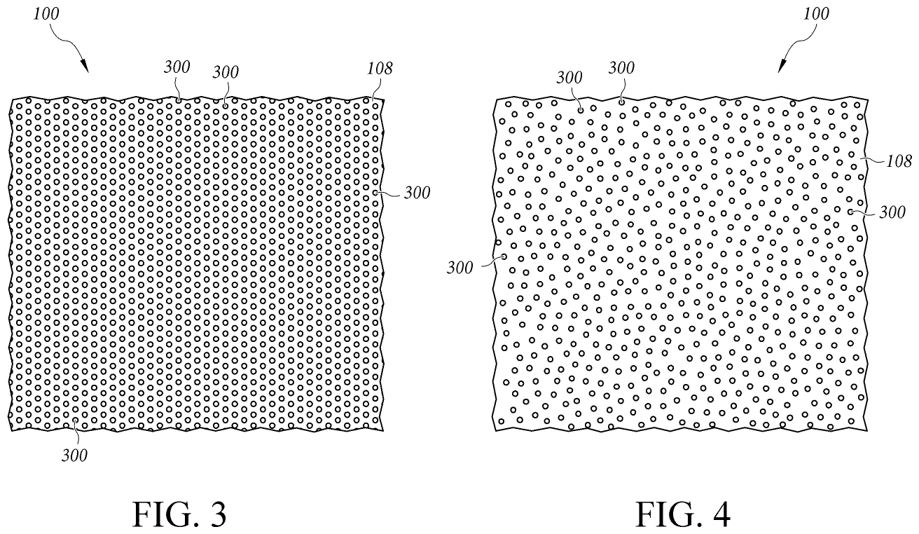

Referring now to FIGS. 3-6, a textured portion of the first surface 108 of the light-transmitting structure 10 is depicted. The light-transmitting structure 10 comprises a plurality of interdiffusion regions 300 associated with the laminated glass substrate 100 and configured to define a light-scattering surface 304 interposed with the first surface 108. The interdiffusion regions 300 each comprise an interdiffusion composition that is transparent and has an interdiffusion refractive index n_{I}. The glass compositions used to form the core layer 102 and the clad layers 104, 106 can have properties configured to enable formation of the interdiffusion regions 300 disclosed herein.

In embodiments, for example, the core glass composition and the clad glass composition have corresponding refractive indexes configured to enable formation of the interdiffusion regions 300. In embodiments, the core glass composition has a core refractive index n_{C} in a range of from about 1.305 to about 1.745, or from about 1.335 to about 1.715, or from about 1.365 to about 1.685, or from about 1.395 to about 1.655, or from about 1.425 to about 1.625, or from about 1.455 to about 1.595, or from about 1.485 to about 1.565, or from about 1.515 to about 1.535, and comprising all sub-ranges and sub-values between these range endpoints. In embodiments, the first clad glass composition has a first clad refractive index n_{CL}, in a range of from about 1.280 to about 1.720, or from about 1.310 to about 1.690, or from about 1.340 to about 1.660, or from about 1.370 to about 1.630, or from about 1.400 to about 1.600, or from about 1.430 to about 1.570, or from about 1.460 to about 1.540, or from about 1.490 to about 1.510, and comprising all sub-ranges and sub-values between these range endpoints.

In embodiments, the first clad refractive index n_{CL1} is configured and/or selected to be lower than the core refractive index n_{C}. In embodiments, a minimum difference between the core refractive index n_{C} and the first clad refractive index n_{CL1} is greater than or equal to 0.005 (e.g., n_{C}−n_{CL1}≥0.005), such as greater than or equal to 0.010, 0.015, 0.020, 0.025, 0.030, 0.035, or more. In embodiments, a maximum difference between the core refractive index nC1 and the first clad refractive index n_{CL1} is less than or equal to 0.650 (e.g., n_{C}−n_{CL1}≤0.650), such as less than or equal to 0.625, 0.600, 0.550, 0.500, 0.450, 0.400, or less.

In embodiments, the second clad layer 106 can be formed from the same clad glass composition as the first clad layer 104 such that the second clad layer 106 has the same attributes (e.g., refractive index, CTE, etc.) described herein with respect to the first clad layer 104. In embodiments, the second clad layer 106 can be formed from a second clad glass composition that is different than the first clad glass composition used to form the first clad layer 104 such that one or more attributes of the second clad layer 106 differs from the attributes of the first clad layer 104. In embodiments, a portion, all, or none of the second surface 110 defined by the second clad layer 106 can include the interdiffusion regions 300 disclosed herein.

In embodiments, the interdiffusion regions 300 comprise discrete volumes of the interdiffusion composition disposed within the first clad layer 104 (e.g., such that the interdiffusion composition is buried below the first surface 108) and/or extending (entirely) through the first clad layer 104 from the core layer 102 (e.g., such that the interdiffusion composition is exposed at the first surface 108). The laminated glass substrate 100 and the interdiffusion regions 300 have a microstructural association achieved by the controlled heating (e.g., via laser irradiation as described hereinbelow) of discrete regions within the laminated glass substrate 100 proximate the first interface 112 between the core layer 102 and the first clad layer 104. The controlled heating promotes local melting and/or interdiffusion between the core glass composition of the core layer 102 and the first clad glass composition of the first clad layer 104 at the discrete (heated) regions to form the interdiffusion regions 300. Additional surface processing, as described hereinbelow, may provide the microstructure at the first surface 108.

As used herein, the term “interdiffusion” refers to the energy-driven diffusional exchange of atoms across an interface between at least two materials or compositions that are in contact. Interdiffusion can result in the formation of an interdiffusion layer between the materials. The interdiffusion composition can comprise one or more further compositions (e.g., a composition gradient) that differ from the core glass composition of the core layer 102 and the clad glass composition of the first clad layer 104. In embodiments, the interdiffusion refractive index n_{I} associated with the interdiffusion composition is higher than the first clad refractive index n_{CL1} associated with the first clad glass composition. In embodiments, the interdiffusion refractive index n_{I} is lower than the core refractive index n_{C} associated with the core glass composition. In embodiments, the interdiffusion refractive index n_{I} is approximately equal to the core refractive index n_{C}. In some embodiments, the interdiffusion refractive index n_{I} is greater than the core refractive index n_{C}. In such embodiments (e.g., n_{I}>n_{C}), the relationship between the indexes can be due to non-linear change between the compositions. One example is boron in 4-coordination number with adding alkali, which will show increasing density and increasing interdiffusion refractive index n_{I}.

FIG. 3 and FIG. 4 are conceptual top-down views of the textured portion of the first surface 108 to illustrate different arrangements of the interdiffusion regions 300. In embodiments, the interdiffusion regions 300 can be associated with the laminated glass substrate 100 in an ordered pattern as shown in FIG. 3. In embodiments, the interdiffusion regions 300 can be associated with the laminated glass substrate 100 in a random pattern as shown in FIG. 4. In embodiments (not shown), the textured portion of the first surface 108 can include a first plurality of the interdiffusion regions 300 arranged in an ordered pattern and a second plurality of the interdiffusion regions 300 arranged in a random pattern.

FIG. 5 is a schematic cross-sectional view through a portion of the textured portion of the light-transmitting structure 10 of FIG. 1 showing embodiments in which the interdiffusion regions 300 extend from the core layer 102 through (e.g., entirely through) the first clad layer 104 to define the light-scattering surface 304 interposed with the first surface 108. The interdiffusion regions 300 each have a concave shape when viewed facing the first surface 108, such as in the direction of arrow 306 shown in FIG. 5. The interdiffusion regions 300 are embedded in the laminated glass substrate 100 such that a majority or an entirety of each interdiffusion region 300 extends below a reference plane 308 defined by the first surface 108. In embodiments, the reference plane 308 can be a global reference plane derived points taken across an entirety of the first surface 108. In other embodiments, the reference plane 308 can be a local reference plane derived from points taken proximate to a portion of the interdiffusion regions 300. In embodiments, a portion (e.g., a relatively small portion) of each interdiffusion region 300 can extend above the reference plane 308 (not shown). In exemplary embodiments, a majority of each interdiffusion region 300 extends below the reference plane 308. For example, more than 60% (e.g., 65%, 70%, 75%, 80%, 85%, 90%, or more) of each interdiffusion region 300 (e.g., the portion of the total mass or the total volume of each interdiffusion region 300) extends below the reference plane 308.

FIG. 6 is a simplified view of the first surface 108 (associated with the laminated glass substrate 100) and the light-scattering surface 304 (associated with the interdiffusion regions 300) configured to collectively define an interface 312 between the light-transmitting structure 10 and an ambient environment to which the light-transmitting structure 10 is exposed (e.g., air). The interface 312 comprises a plurality of peaks and valleys indicated by numerous instances of the letters P and V, respectively, in FIG. 6. The peaks and valleys occur at points along the cross-section (e.g., the cross-section extends along the x axis) where a curve drawn along the textured portion of the first surface 108 would have a slope equal to zero when a thickness 316 (FIG. 5) of the light-transmitting structure 10 is shown on the y axis.

Referring now to FIG. 5 and FIG. 6, the interdiffusion regions 300 define the valleys of the interface 312 (e.g., the valleys are configured as depressions that extend into the first clad layer 104) and the first surface 108 defines the peaks (e.g., along the reference plane 308). The distance between one of the peaks and (an adjacent) one of the valleys (e.g., the peak-to-valley distance 320) corresponds to a height or depth of each interdiffusion region 300. In embodiments, an average roughness of the interface 312 comprises a peak-to-valley distance 320 in a range of about 0.1 μm to about 72.5 μm, or from about 0.4 μm to about 65 μm, or from about 0.7 μm to about 57.5 μm, or from about 1 μm to about 50 μm, or from about 1.3 μm to about 42.5 μm, or from about 1.6 μm to about 35 μm, or from about 1.9 μm to about 27.5 μm, or from about 2.2 μm to about 20 μm, or from about 1 μm to about 57.5 μm, or from about 1 μm to about 42.5 μm, or from about 1 μm to about 35 μm, or from about 1 μm to about 27.5 μm, or from about 1 μm to about 20 μm, and comprising all sub-ranges and sub-values between these range endpoints. The height or depth of each interdiffusion region 300, or an average height or depth of a group of interdiffusion regions 300 within a specified area or region, relative to a baseline (e.g., reference plane 208) can be measured using a profilometer and a scan length (e.g., approximately 5 mm).

The glass compositions used to form the core layer 102 and the clad layers 104, 106 can have properties configured to influence and/or control the shape of the interdiffusion regions 300 disclosed herein. In embodiments, the core glass composition and the clad glass composition can vary with respect to their durability in an etchant. For example, the core glass composition used to form core layer 102 can have a dissolution rate in the etchant (e.g., a core etch rate) that is different than a dissolution rate of the clad glass composition used to form the first clad layer 104 and/or the second clad layer 106 (e.g., a clad etch rate) in the same etchant. Since the interdiffusion composition is derived from the local melting and/or interdiffusion between the core glass composition and the clad glass composition, the interdiffusion composition can have a dissolution rate in the etchant (e.g., an interdiffusion etch rate) that is intermediate the core etch rate and the clad etch rate. In embodiments, the clad etch rate, the interdiffusion etch rate, and the core etch rate can have the following relationship: clad etch rate<interdiffusion etch rate<core etch rate. The different durability (e.g., etch rates) among each of the core glass composition, the clad glass composition, and the interdiffusion composition in such embodiments can make it possible to form the concave shape of the portion of the interdiffusion regions 300 (e.g., the depressions) that defines the light-scattering surface 304 as described hereinbelow in connection with a method for forming the light-transmitting structure 100.

In embodiments, some of the interdiffusion regions 300 fused with the laminated glass substrate 100 can differ from other interdiffusion regions 300 fused with the laminated glass substrate 100 relative to the same or different surfaces thereof. For example, the light-transmitting structure 10 can include a first plurality of the interdiffusion regions 300 and a second plurality of the interdiffusion regions 300 both disposed relative to the first surface 108. In embodiments, the first and second pluralities of the interdiffusion regions 300 can differ with respect to the height or depth of the interdiffusion regions, such that the first plurality of interdiffusion regions has a height or depth that is smaller than a height or depth of the second plurality of interdiffusion regions. For example, the first plurality of interdiffusion regions can have peak-to-valley distance in a range of from about 1 μm to less than about 25 μm and the second plurality of interdiffusion regions can have a peak-to-valley distance in a range of from equal to about 25 μm to about 50 μm.

In embodiments, the first and second pluralities of the interdiffusion regions 300 can differ with respect to other physical attributes, such as composition, refractive index, feature size or width, amount or extent (i.e., percent volume or percent mass) above or below the reference plane 308, and/or other physical attributes. In embodiments, each interdiffusion region 300 has a feature size or width 324 measured in a lateral direction, normal to a thickness 316 (FIG. 5) of the laminated glass substrate 100, as the largest distance between opposed sides of the interdiffusion region 300. In embodiments, the widths 324 of the interdiffusion regions 300 are in a range of from about 0.1 μm to about 50 μm, or from about 0.5 μm to about 40 μm, or from about 1 μm to about 25 μm. In embodiments, compositions are “different” when the identity, arrangement, and/or ratio of the elements making up the compositions differ (e.g., differ by a measurable or otherwise detectable attribute).

The interdiffusion regions 300 disclosed herein form microstructures with AG properties and change the local refractive index at microns to tens of microns dimensions. In other words, the interdiffusion regions 300 co-locate the AG features and the index changes relative to the laminated glass substrate 100. Without being bound by theory, it is believed that by introducing co-located AG features and index changes into the laminated glass substrate 100, the distinctness-of-image (DOI) and the sparkle of the laminated glass substrate 100 can be concurrently lowered. As such, it is believed that introducing interdiffusion regions as described herein (e.g., interdiffusion regions with different compositions and different refractive indices compared to the laminated glass substrate and/or the first clad layer thereof) may allow for improvements in both the DOI and the sparkle of the laminated glass substrate 100 and accordingly the DOI and the sparkle of the light-transmitting structure 10. It is similarly believed that by introducing interdiffusion regions as described herein, the laminated glass substrate 100 may have comparatively better optical parameters, such as DOI and sparkle, when compared to textured substrates that do not have the interdiffusion regions described herein.

The textured portion of the light-transmitting structure 10 can have specific optical parameters, such as coupled DOI and sparkle. For example, the textured light-transmitting structure 10 can be characterized by sparkle. “Sparkle,” “sparkle contrast,” “display sparkle,” “pixel power deviation,” “PPD,” or like terms refers to the visual phenomenon that occurs when a textured transparent surface is combined with a pixelated display. Generally speaking, quantitation of sparkle involves imaging a lit display or simulated display with the textured surface in the field of view. The calculation of sparkle for an area P is equal to σ(P)/μ(P), where σ(P) is the standard deviation of the distribution of integrated intensity for each display pixel contained within area P divided by the mean intensity μ(P). Following the guidance in: (1) J. Gollier, et al., “Apparatus and method for determining sparkle,” U.S. Pat. No. 9,411,180B2, United States Patent and Trademark Office, 20 Jul. 2016; (2) A. Stillwell, et al., “Perception of Sparkle in Anti-Glare Display Screens,” JSID 22(2), 129-136 (2014); and (3) C. Cecala, et al., “Fourier Optics Modeling of Display Sparkle from Anti-Glare Cover Glass: Comparison to Experimental Data”, Optical Society of America Imaging and Applied Optics Congress, JW5B.8 (2020); one skilled in the art can build an imaging system to quantify sparkle. Alternatively, a commercially available system (e.g., the SMS-100, Display Messtechnik & Systeme GmbH & Co. KG, Germany) can also be used.

As described herein, sparkle is measured with a 140 PPI display. A 140 PPI display (e.g., Z50, Lenovo Group Limited, Hong Kong) with only the green subpixels lit (R=0, B=0, G=255), at full display brightness is imaged using a f=50 mm lens/machine vision camera combination (e.g., C220503 1:2.8 50 mm Φ30.5, Tamron, Japan) and Stingray F-125 B, Allied Vision Technologies GmbH, Germany). The lens settings are aperture=5.6, depth of field=0.3, working distance=about 290 mm; with these settings, the ratio of display pixels to camera pixels is approximately 1 to 9. The field of view for analysis contains approximately 7500 display pixels. Camera settings have the gain and gamma correction turned off. Periodic intensity variations from, e.g., the display, and non-periodic intensity variations, e.g., dead pixels, are removed during analysis prior to the calculation of sparkle.

In embodiments, the textured portion of the light-transmitting structure 10 can have a sparkle at 140 PPI of less than or equal to 3%. For example, in embodiments, the textured portion of the light-transmitting structure 10 can have a sparkle at 140 PPI of less than or equal to 2%, less than or equal to 1.9%, less than or equal to 1.8%, less than or equal to 1.7%, less than or equal to 1.6%, less than or equal to 1.5%, less than or equal to 1.4%, less than or equal to 1.3%, less than or equal to 1.2%, less than or equal to 1.1%, or even less than or equal to 1.0%.

The textured light-transmitting structure 10 described herein can further be characterized by distinctness-of-image. “Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angle. The values obtained from these measurements are combined to provide a DOI value. In particular, DOI is calculated according to equation (1):

$$DOI = [ 1 - \frac{{R}_{OS}}{{R}_{S}} ] \times 10 \qquad ( 1 )$$

Where Rs is the relative amplitude of reflectance in the specular direction and Ros is the relative amplitude of reflectance in an off-specular direction. As described herein, Ros, unless otherwise specified, is calculated by averaging the reflectance over an angular range from 0.2° to 0.4° away from the specular direction. Rs can be calculated by averaging the reflectance over an angular range of ±0.05° centered on the specular direction. Both Rs and Ros were measured using a goniophotometer (Rhopoint Instruments) that is calibrated to a certified black glass standard, as specified in ASTM procedures D523 and D5767. The goniophotometer uses a detector array in which the specular angle is centered about the highest value in the detector array. DOI was also evaluated using 1-side (black absorber coupled to rear of glass) method. The 1-side measurement allows the gloss, reflectance, and DOI to be determined for a single surface (e.g., a single roughened surface) of the glass article. The Ros/Rs ratio can be calculated from the average values obtained for Rs and Ros as described above. “20° DOI,” or “DOI 20°” refers to DOI measurements in which the light is incident on the sample at 20° off the normal to the glass surface, as described in ASTM D5767. The scale value obtained with the measuring procedures of ASTM D5767 range from 0 to 10 with a value of 10 representing perfect DOI (image clarity).

In embodiments, the textured portion of the light-transmitting structure 10 can have a coupled DOI of less than 60%. For example, in embodiments, the textured portion of the light-transmitting structure 10 can have a coupled DOI of less than 55%, less than 50%, less than 45%, less than 40%, less than 35%, less than 30%, less than 25%, less than 20%, less than 15%, less than 10%, or even less than 5%.

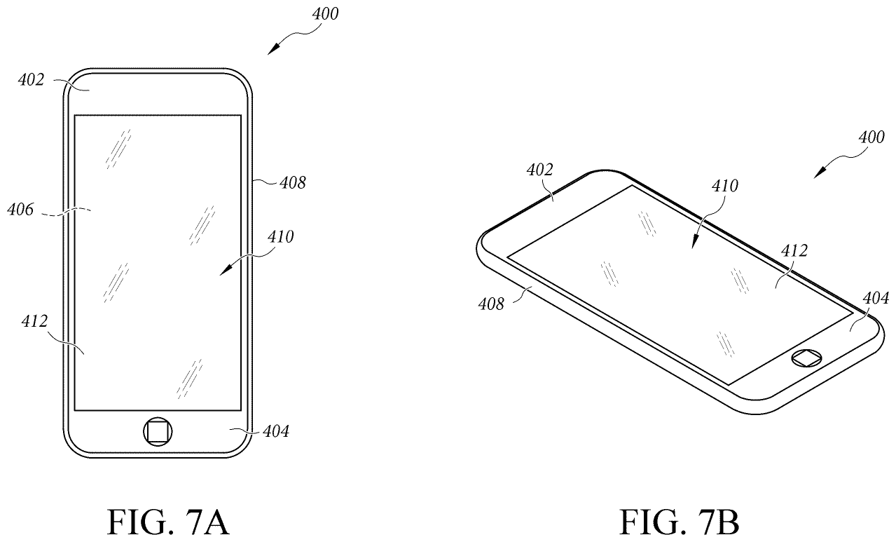

The textured light-transmitting structure 10 disclosed herein, as-formed or following ion exchange, can be incorporated into another article such as an article with a display or display articles (e.g., consumer electronics, including mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating the textured light-transmitting structure disclosed herein is shown in FIG. 7A and FIG. 7B. Specifically, FIG. 7A and FIG. 7B show a consumer electronic device 400 including a housing 402 having front 404, back 406, and side surfaces 408; electrical components (not shown) that are at least partially inside or entirely within the housing and including at least a controller, a memory, and a display 410 at or adjacent to the front surface of the housing; and a cover substrate 412 at or over the front surface of the housing such that it is over the display. In embodiments, at least a portion of at least one of the cover substrate 412 and/or the housing 402 can include the textured light-transmitting structure disclosed herein.

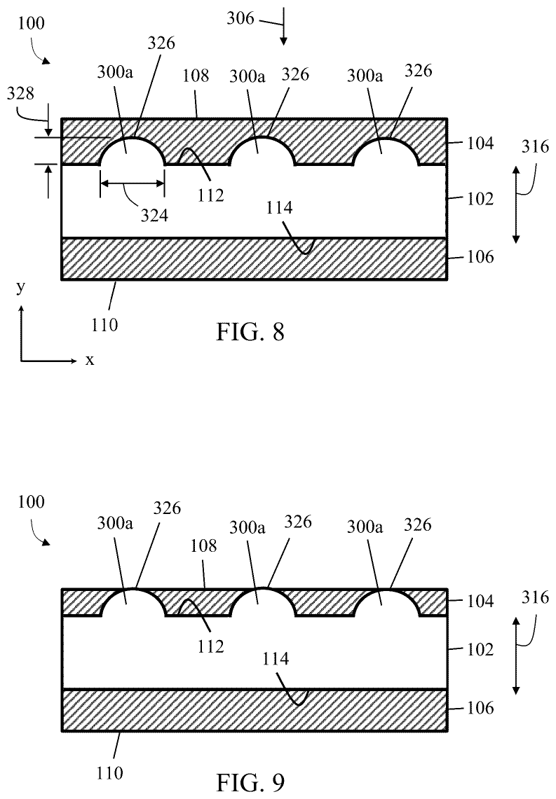

Referring now to FIG. 8 and FIG. 9, schematic cross-sectional views through a portion of a laminated glass substrate 100 are shown to illustrate aspects of a method for forming a light-transmitting structure. The method is also described with reference to the light-transmitting structure 10 of FIGS. 1-6 to facilitate a better understanding of the different aspects of the method. The method includes irradiating a laminated glass substrate 100 with a beam from a laser. The laminated glass substrate 100 comprises a core layer 102 and a first clad layer 104 fused to the core layer 102. The core layer 102 comprises a core glass composition that is transparent and has a core refractive index n_{C}. The first clad layer 104 defines a first surface 108 of the laminated glass substrate 100. The first clad layer 104 comprises a first clad glass composition that is transparent and has a first clad refractive index n_{CL1} that is lower than the core refractive index n_{C}. The core refractive index n_{C} and the first clad refractive index n_{CL1} can have the minimum difference and/or the maximum difference previously described with reference to FIGS. 1-6.

The irradiating is configured to form a plurality of interdiffusion regions 300 that extend from the core layer 102 into the first clad layer 104. Each interdiffusion region 300 comprises an interdiffusion composition that is transparent and has an interdiffusion refractive index n_{I} that is higher than the first clad refractive index n_{CL1}. In embodiments, the irradiating is performed on a laminated glass substrate that is not textured. In embodiments, the irradiating is performed on a portion of a laminated glass substrate that is not textured, although other portions of the laminated glass substrate can be textured.

The irradiating further comprises directing a focus of the beam of the laser at a plurality of regions proximate a first interface 112 between the core layer 102 and the first clad layer 104 to form the interdiffusion regions 300. In embodiments, the irradiating further comprises heating each region at which the focus of the beam is directed to a temperature at or above the working points (e.g., the temperature corresponding to the viscosity of 10⁴ P) of the core glass composition of the core layer 102 and the first clad glass composition of the first clad layer 104.

In embodiments, the irradiating is configured to cause a portion of the core glass composition of the core layer 102 and a portion of the first clad glass composition of the first clad layer 104 proximate the irradiation to have one or more of composition-related changes (e.g., interdiffusion), to have phase-related changes, and/or volumetric-related changes (e.g., due laser-induced ablation). In embodiments, the laser is an ultrafast laser. The ultrafast laser is configured to emit ultrashort pulses of the order of picoseconds or femtoseconds.

The irradiating further comprises setting one or more parameters of the laser. The laser parameters can include a laser type, a center wavelength, a repetition rate, an average power, a pulse duration or pulse length, a pulse energy, a beam shape, a beam size (e.g., diameter), a focal length, a spot size, a scanning method, a scanning speed, a scanning pitch spacing, a scanning line spacing, a laser fluence, as well as other parameters.

In embodiments, the beam can have a diameter in a range of from about 1 μm to about 100 μm, or from about 2.5 μm to about 80 μm, or from about 5 μm to about 60 μm. In embodiments, the pulse length is in a range of from about 1 ps to about 100 ps, or from about 10 ps to about 90 ps, or from about 20 ps to about 80 ps. In embodiments, each pulse can have a pulse energy in a range of from about 0.1 pJ to about 100 pJ, or from about 0.5 pJ to about 75 pJ, or from about 1 pJ to about 50 pJ.

Details of the one or more laser parameters, including the settings thereof, are described in the Examples section of this disclosure.

FIG. 8 depicts the interdiffusion regions 300 after the irradiating and prior to any further steps of the method. As shown in FIG. 8, the interdiffusion regions 300 extend from the core layer 102 and into the first clad layer 104 and terminate at peaks 326 that have a domed or convex shape when viewed facing the first surface 108, such as in the direction of arrow 306. The peaks 326 occur at points along the cross-section (e.g., the cross-section extends along the x axis) where a curve drawn along the interface of the interdiffusion regions 300 and the first clad layer 104 would have a slope equal to zero when a thickness 316 of the laminated glass substrate 100 is shown on the y axis.

In embodiments, the peaks 326 are buried within the first clad layer 104 below the first surface 108. In embodiments (not shown), depending on the laser parameters, processing conditions, and configuration of the laminated glass substrate 100, at least some interdiffusion regions 300 can extend (entirely) through the first clad layer 104 such that at least portions of the peaks 326 are exposed at the first surface 108 after the irradiating and prior to any further steps of the method. The interdiffusion regions 300 with the domed peaks 326, as shown in FIG. 8 and FIG. 9, can be referred to as domed interdiffusion regions 300a.

Referring still to FIG. 8, each domed interdiffusion region 300a has a height 328 measured in a thickness direction of the laminated glass substrate 100 (e.g., the direction of arrow 316) as the largest distance between the core layer 102 and the peak 326 of the domed interdiffusion region 300a. In embodiments, the heights 328 of the domed interdiffusion regions 300a can be in a range of from about 0.1 μm to about 300 μm, or from about 0.250 μm to about 270 μm, or from about 0.400 μm to about 240 μm, or from about 0.550 μm to about 210 μm, or from about 0.700 μm to about 180 μm, or from about 0.850 μm to about 150 μm, or from about 1 μm to about 120 μm, or from about 0.1 μm to about 260 μm, or from about 0.1 μm to about 220 μm, or from about 0.1 μm to about 180 μm, or from about 0.1 μm to about 140 μm, or from about 0.1 μm to about 100 μm, and comprising all sub-ranges and sub-values between these range endpoints.

Each domed interdiffusion region 300a has a width 324 measured in a lateral direction of the laminated glass substrate, normal to the thickness direction 316, as the largest distance between opposed sides of the domed interdiffusion region 300a. In embodiments, the widths 324 of the domed interdiffusion regions 300a can be in a range of from about 1 μm to about 25 μm.

Referring now to FIG. 9, the method further includes etching the laminated glass substrate 100 in an etchant after the irradiating to remove a portion of the first clad layer 104 and expose upper portions of the interdiffusion regions 300, 300a. FIG. 9 depicts an intermediate step of the etching in which a first portion of the first clad layer 104 is removed to expose the upper portions (e.g., the peaks 326 and portions proximate thereto) of the domed interdiffusion regions 300a. In embodiments, the etching can be configured not to remove any portions of the second clad layer 106, such as illustrated in FIG. 9. In such embodiments, the etchant can be selectively applied only to the first surface 108 to achieve the configuration illustrated in FIG. 9. Such selective application of the etchant can comprise applying an etch-resistant mask to the surfaces of the laminated glass substrate 100 for which material removal via etching is not desired. In other embodiments, the etching removes portions of the first clad layer 104 and portions of the second clad layer 106, such as shown in FIG. 5. In embodiments, the etching comprises wet etching.

Referring now to FIG. 5 and FIG. 9, the etching is continued from the intermediate etching step depicted in FIG. 9 and further comprises removing a second portion of the first clad layer 104 and removing portions of the exposed upper portion of the interdiffusion regions 300 to define a light-scattering surface 304 interposed with the first surface 108, as shown in FIG. 5. The continued etching changes the upper portions of the interdiffusion regions 300 from the domed (convex) shape, as shown in FIG. 9, to a collapsed (concave) shape that extends below a reference plane 308 defined by the first surface 108, as shown in FIG. 5. This change in shape while also extending below the reference plane 308 is due to the different dissolution rates (e.g., etch rates) of the core glass composition used to form the core layer 102 and the clad glass composition used to form the first clad layer 104.

In embodiments, for example, the core glass composition has a core etch rate in the etchant that is faster than a clad etch rate of the first clad glass composition in the (same) etchant. In embodiments, the core etch rate is configured to be at least 1.5 times faster, at least 2 times faster, at least 5 times faster, at least 10 times faster, at least 20 times faster, or at least 100 times faster than the first clad etch rate. Additionally, or alternatively, a ratio of the core etch rate to the first clad etch rate is about 5, about 10, about 15, about 20, about 25, about 30, about 35, about 40, about 45, about 50, about 55, about 60, about 65, about 70, about 75, about 80, about 85, about 90, about 95, about 100, or any ranges defined by any combination of the stated values. In embodiments, the etchant can be any etchant the results in the etch rate differential disclosed herein.

Since the interdiffusion composition of the interdiffusion regions 300 is derived from the local melting and/or interdiffusion between the core glass composition and the clad glass composition, the interdiffusion composition can have an interdiffusion etch rate that is intermediate the core etch rate and the clad etch rate (e.g., clad etch rate<interdiffusion etch rate<core etch rate). As such, the portions of the interdiffusion regions 300 exposed to the etchant will dissolve faster than the portions of the first clad layer 104 exposed to the etchant, thereby forming the concave shape of the portion of the interdiffusion regions 300 that defines the light-scattering surface 304 (e.g., the valleys V in FIG. 6).

The first surface 108 (associated with the laminated glass substrate 100) and the light-scattering surface 304 (associated with the interdiffusion regions 300) are configured to collectively define an interface 312 between the light-transmitting structure 10 and an ambient environment to which the light-transmitting structure 10 is exposed (e.g., air). In embodiments, the interface 312 comprises a plurality of peaks and valleys. The interface 312 can have an average roughness that comprises a peak-to-valley distance 320 in the range previously described with reference to FIG. 5 and FIG. 6.

In embodiments, the method further comprises preheating the laminated glass substrate 100 to a preheat temperature prior to the irradiating. The pre-heat temperature can be in a range of from about 200° C. to about 600° C.

### EXAMPLES

Various embodiments of the present disclosure can be better understood by reference to the following Examples which are offered by way of illustration. The present disclosure is not limited to the Examples given herein.

### Example 1—Sample Preparation

Laminated glass substrate samples having a three-layer configuration (e.g., clad-core-clad) as described with reference to FIG. 1 were made using the laminate (dual) fusion draw process described with reference to FIG. 2. The laminated glass substrate samples were formed from two different combinations or pairs of core glass compositions and clad glass composition. Table 1 lists the chemical constituents and select physical properties for the glass compositions of the different combinations, e.g., Combination 1 (C1) comprising clad glass composition Clad_{C1} and core glass composition Core_{C1} and Combination 2 comprising clad glass composition Clad_{C2} and core glass composition Core_{C2}, used in the Examples. The chemical constituents are expressed in terms of weight percent on an oxide basis, density is reported in g/cm³ at room temperature, average coefficient of linear thermal expansion (CTE) is reported in terms of ×10⁻⁷/° C. between 0° C. and 300° C., and Refractive Index is reported at λ=546 nm.

TABLE 1

| Combinations | Combination 1 (C1) | | Combination 2 (C2) | |
|---|---|---|---|---|
| Compositions [wt %] | Clad_{C1} | Core_{C1} | Clad_{C2} | Core_{C2} |
| SiO₂ | 60.19 | 56.57 | 51.05 | 65.78 |
| Al₂O₃ | 11.66 | 14.38 | 21.02 | 13.75 |
| B₂O₃ | 17.75 | 7.2 | 14.77 | 0 |
| CaO | 7.07 | 6.13 | 0 | 0.48 |
| Na₂O | 0 | 0 | 12.85 | 13.67 |
| K₂O | 0 | 8.04 | 0 | 1.75 |
| MgO | 1.38 | 1.48 | 0 | 4.11 |
| SrO | 1.79 | 6.04 | 0 | 0 |
| SnO₂ | 0.16 | 0.16 | 0.22 | 0.46 |
| Total | 100 | 100 | 99.91 | 100 |
| Physical Properties | | | | |
| Density [g/cm³] | 2.35 | 2.507 | 2.331 | 2.436 |
| CTE | 35 | 62.4 | 77.3 | 82.8 |
| [×10⁻⁷/° C. at 0-300° C.] | | | | |
| Refractive Index | 1.5051 | 1.5182 | 1.493 | 1.5015 |
| [λ = 546 nm] | | | | |

The laminated glass substrate samples made according to Combination 1 had a total thickness of 500 μm (0.5 mm) and a core/clad thickness ratio of 9 with symmetric clad layers such that the core thickness was approximately 450 μm (0.450 mm) and the clad thickness of each clad layer was approximately 25 μm (0.025 mm). The core glass composition Core_{C1} had a core refractive index n_{C} of approximately 1.518. The clad glass composition Clad_{C1} had a clad refractive index n_{CL} of approximately 1.505. The difference between the core refractive index n_{C} and the clad refractive index n_{CL} was approximately 0.01. The core glass composition Core_{C1} had a core coefficient of thermal expansion CTE_{C} of approximately 62.4×10⁻⁷/C. The clad glass composition Clad_{C1} had a clad coefficient of thermal expansion CTE_{CL} of approximately 35×10⁻⁷/° C. The difference between CTE_{C} and CTE_{CL} was approximately 27.4×10⁻⁷/° C. The core glass composition Core_{C1} had a higher CTE and a higher refractive index when compared to the clad glass composition Clad_{C1}.

The laminated glass substrate samples made according to Combination 2 had a total thickness of 1000 μm (1.0 mm) and a core/clad thickness ratio of 3 with symmetric clad layers such that the core thickness was approximately 750 μm (0.750 mm) and clad thickness of each clad layer was approximately 125 μm (0.125 mm). The core glass composition Core_{C2} had a core refractive index n_{C} of approximately 1.502. The clad glass composition Clad_{C2} had a clad refractive index n_{CL} of approximately 1.493. The difference between the core refractive index n_{C} and the clad refractive index n_{CL} was approximately 0.01. The core glass composition Core_{C2} had a core coefficient of thermal expansion CTE_{C} of approximately 82.8×10⁻⁷/° C. The clad glass composition Clad_{C2} had a clad coefficient of thermal expansion CTE_{CL} of approximately 77.3×10⁻⁷/° C. The difference between CTE_{C} and CTE_{CL} was approximately 5.5×10⁻⁷/° C. The core glass composition Core_{C2} had a higher CTE and a higher refractive index when compared to the clad glass composition Clad_{C2}.

### Example 2—Laser Processing

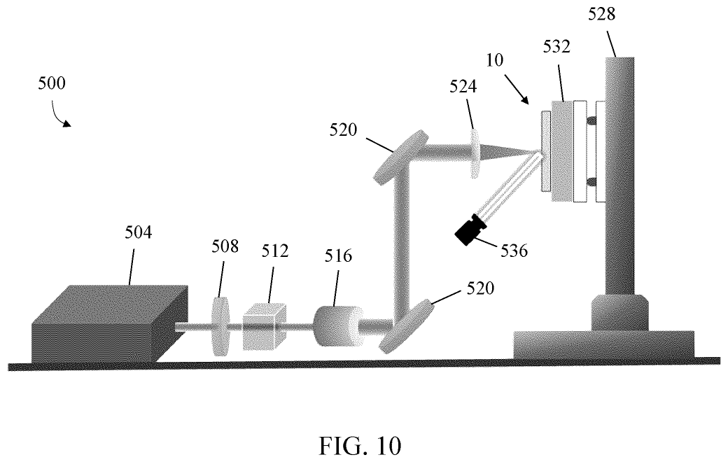

FIG. 10 is a schematic depiction of a laser system 500 configured to perform the laser processing of the laminated glass substrate samples according to the Examples. The laser system 500 includes an ultrafast laser 504 (TruMicro 5050 Picosecond Laser, TRUMPF Group). The ultrafast laser 504 was selected to form the interdiffusion regions in the laminated glass substrate samples due to its local heating effect. The laser system 500 further includes various beam guidance components, such as a half-wave plate 508, a beam splitter 512, a beam expander 516, mirrors 520, and a lens 524. In configurations of the laser system 500, the lens 524 has an aperture of approximately 17 mm and a focal length of approximately 30 mm. The laser system 500 also include an X-Y-Z linear stage 528 and a vacuum chuck and tilt platform configured to manipulate the laminated glass substrate samples. The laser system 500 can also include a camera 536.

Table 2 includes a list of typical ultrafast laser processing conditions used to form the interdiffusion regions 300 in the laminated glass substrate samples according to the Examples.

TABLE 2

| Parameter | Symbol | Unit | Values* |
|---|---|---|---|
| Wavelength | λ | μm | 1.03 |
| Beam diameter | wᵢ | mm | 14 |
| Lens focal length | F | mm | 45 |
| Focal spot diameter | 2w₀ | μm | 4.22 |
| Rayleigh range | z_{R} | μm | 13.56 |
| Average power | P | W | 4.8 |
| Frequency | F | KHz | 800 |
| Laser pulse energy | E | μJ | 6 |
| Feed rate | vₓ | mm/s | 50 |

In Table 2, the asterisk (*) is used to indicate the noted values are typical, but there can be variances as indicated herein. The operating wavelength used for the laser processing was approximately 1 μm with nonlinear absorption. The pulse duration was around 10 ps. The beam is Gaussian beam with 2.32 μm focus diameter. In most laminated glass substrate samples, 6 μJ pulse energy laser was used with 50 mm/s scan rate. It is found that with reduced pulse energy (e.g., from about 1.5 μJ to about 2 μJ), (micro)cracking can be suppressed, but the formed interdiffusion features may not be clearly visible from the edge of the samples. In configurations of the laser system 500, the scanning speed was maintained at 100 mm/s. Preheating of the laminated glass substrate samples may be beneficial since it can reduce localized transient and residual thermal stress caused by the rapid laser heating process.

### Example 3—Analysis of Sample 1

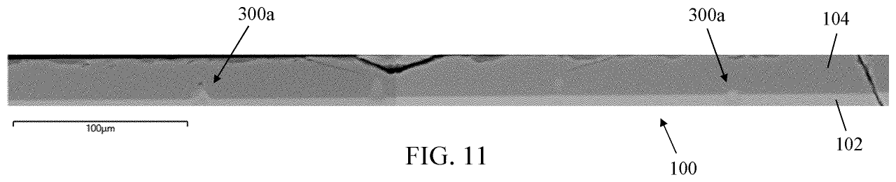

A laminated glass substrate sample was made from the Combination 1 (C1) glass compositions (hereinafter “Sample 1”). FIG. 11 is a scanning electron microscope (SEM) image of interdiffusion regions 300a repeatably formed via ultrafast laser in Sample 1. The SEM image shows approximately 5 μm of local mixing between the core and clad glass compositions and a higher refractive index (i.e., indicated by lighter shade of gray) in the domed interdiffusion regions 300a that extend from the core layer 102 into the clad layer 104. The laser processing of Sample 1-1 used lower laser energy to avoid sample fracture due to the small thickness of the clad layer 104 (e.g., approximately 25 μm). The interdiffusion regions 300a were formed with several microns in width (e.g., left and right in the view of FIG. 11) and height protruding into the clad layer 104 (e.g., up and down in the view of FIG. 11).

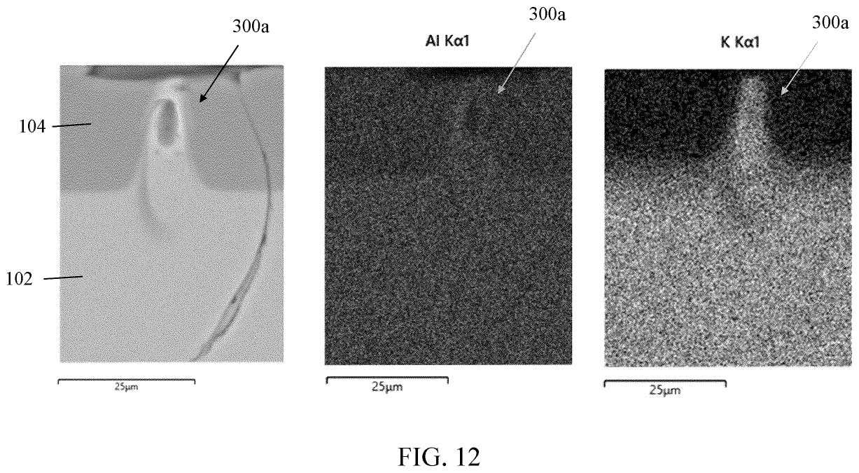

FIG. 12 is a series of images including (from left to right) an enlarged SEM image of an interdiffusion region 300a formed in Sample 1-1 and two corresponding energy dispersive spectrometry (EDS) elemental mapping images of the SEM image area. The interdiffusion region 300a shows significant K₂O interdiffusion and slight Al₂O₃ interdiffusion after the laser processing, as shown in the right and middle EDS elemental mapping images, respectively, of FIG. 12. The laser processing for laminated glass substrate samples made from the Combination 1 glass compositions required specific control of power and scan speed to avoid excessive stress in the samples and/or unintended plasma ablation.

### Example 3—Analysis of Sample 2

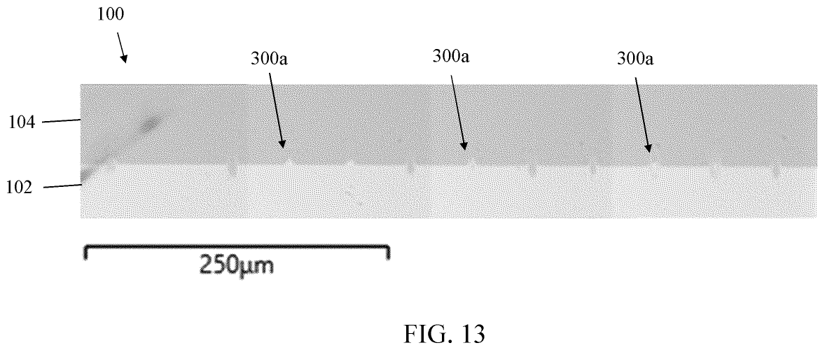

A laminated glass substrate sample was made from the Combination 2 (C2) glass compositions (hereinafter “Sample 2”). FIG. 13 is a SEM image of interdiffusion regions 300a repeatably formed via ultrafast laser in Sample 2. The SEM image shows the domed interdiffusion regions 300a are repeatably well formed along the interface between the core layer 102 and the clad layer 104.

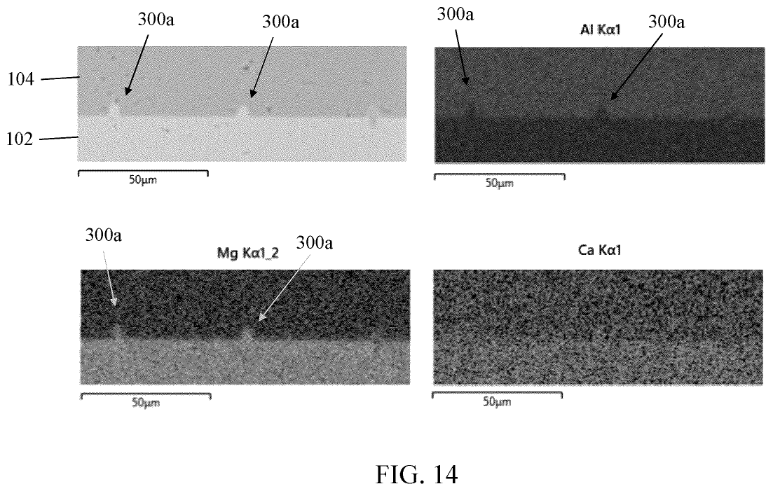

FIG. 14 is a group of images including an enlarged SEM image of a group of interdiffusion regions 300a formed in Sample 2 and three corresponding EDS elemental mapping images of the SEM image area. The EDS elemental mappings show clear composition interdiffusion between the clad glass composition and the core glass composition in the laser processed regions.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A light-transmitting structure, comprising:
a laminated glass substrate comprising a core layer and a first clad layer fused to a first side of the core layer, the core layer comprising a core glass composition that is transparent and has a core refractive index n_{C}, the first clad layer defining a first surface of the laminated glass substrate and comprising a first clad glass composition that is transparent and has a first clad refractive index n_{CL1} that is lower than the core refractive index n_{C}; and
a plurality of interdiffusion regions extending from the core layer and through the first clad layer to define a light-scattering surface interposed with the first surface, each interdiffusion region comprising an interdiffusion composition that is transparent and has an interdiffusion refractive index n_{I} that is higher than the first clad refractive index n_{CL1}, the first surface and the light-scattering surface defining an interface to an ambient environment.

2. The light-transmitting structure of claim 1, wherein n_{C}−n_{CL1}≥0.01.

3. The light-transmitting structure of claim 1, wherein n_{CL1}<n_{I}.

4. The light-transmitting structure of claim 2, wherein core refractive index n_{C} is in a range of from about 1.305 to about 1.745.

5. The light-transmitting structure of claim 2, wherein the first clad refractive index n_{CL1} is in a range of from about 1.280 to about 1.720.

6. The light-transmitting structure of claim 1, wherein the interface comprises a plurality of peaks and valleys, and wherein the interdiffusion regions are configured to define the valleys.

7. The light-transmitting structure of 6, wherein the valleys are configured as depressions that extend into the first clad layer.

8. The light-transmitting structure of claim 6, wherein an average roughness of the interface comprises a peak-to-valley distance in a range of from about 1 μm to about 50 μm.

9. The light-transmitting structure of claim 1, wherein most of each interdiffusion region extends below a reference plane defined by the first surface.

10. The light-transmitting structure of claim 9, wherein at least 80% of each interdiffusion region extends below the reference plane.

11. The light-transmitting structure of claim 1, wherein the interdiffusion composition has an interdiffusion etch rate in an etchant that is faster than a clad etch rate of the first clad glass composition in the etchant.

12. The light-transmitting structure of claim 1, wherein the core glass composition comprises a higher amount of alkali oxide R₂O than the first clad glass composition, and wherein R is at least one of Li, Na, and K.

13. The light-transmitting structure of claim 1, wherein the core glass composition has an average core coefficient of thermal expansion CTE_{C}, and the first clad glass composition has an average first clad coefficient of thermal expansion CTE_{CL1} that is lower than the CTE_{C}.

14. The light-transmitting structure of claim 1, wherein the laminated glass substrate comprises a second clad layer fused to a second side of the core layer, the second clad layer comprising a second clad glass composition that is transparent and has a second clad refractive index n_{CL2} that is lower than the core refractive index n_{C}.

15. The light-transmitting structure of claim 14, wherein a first clad thickness of the first clad layer is less than a second clad thickness of the second clad layer.

16. The light-transmitting structure of claim 1, where each interdiffusion region has a width measured in a lateral direction, normal to a thickness of the laminated glass substrate, as the largest distance between opposed sides of the interdiffusion region, the widths of the interdiffusion regions are in a range of from about 0.5 μm to about 40 μm.

17. A method for forming a light-transmitting structure, comprising:
irradiating a laminated glass substrate with a beam from a laser, the laminated glass substrate comprising a core layer and a first clad layer fused to the core layer, the core layer comprising a core glass composition that is transparent and has a core refractive index n_{C}, the first clad layer defining a first surface of the laminated glass substrate and comprising a first clad glass composition that is transparent and has a first clad refractive index n_{CL1} that is lower than the core refractive index n_{C},
wherein the irradiating is configured to form a plurality of interdiffusion regions that extend from the core layer into the first clad layer, each interdiffusion region comprising an interdiffusion composition that is transparent and has an interdiffusion refractive index n_{I} that is higher than the first clad refractive index n_{CL1}.

18. The method of claim 17, wherein the irradiating further comprises directing a focus of the beam at a plurality of regions proximate a first interface between the core layer and the first clad layer to form the interdiffusion regions.

19. The method of claim 17, further comprising etching the laminated glass substrate in an etchant after the irradiating to remove a portion of the first clad layer and expose upper portions of the interdiffusion regions, the upper portions of the interdiffusion regions configured to define a light-scattering surface interposed with the first surface.

20. The method of claim 19, wherein the etching comprises removing portions of the exposed upper portions of the interdiffusion regions.
